(19) United States
(12) Patent Application Publication
(10) Pub. No.: US 2016/0002575 A1
(43) Pub. Date: Jan. 7, 2016

(54) CHEMICAL SOLUTION AND METHOD OF UNCLOGGING STOPPED TOILETS

(71) Applicant: Steve KAYLOR, Valencia, CA (US)

(72) Inventor: Steve KAYLOR, Valencia, CA (US)

(21) Appl. No.: 14/793,336

(22) Filed: Jul. 7, 2015

Related U.S. Application Data
(60) Provisional application No. 62/021,468, filed on Jul. 7, 2014.

(51) Int. Cl. C11D 7/06; B08B 3/08; C01D 1/04; B08B 9/027

(52) U.S. Cl. CPC C11D 7/06; B08B 9/027; B08B 3/08; C01D 1/04

(57) ABSTRACT

A method for employing a particular chemical compound formed with sodium hydroxide to rapidly clear clogs in drains, such as clogs caused by organic debris in toilet drains. A user may dispense this chemical compound in solid or powder form into the drain, following which the chemical will attack the source of the clog and potentially clear the drain.

### PRIORITY CLAIM

This application claims the benefit of the filing date of U.S. Provisional Patent Application No. 62/021,468, filed Jul. 7, 2014, which is incorporated herein by reference in its entirety.

### BACKGROUND

Current models of bathroom toilets can occasionally, during unusual or even routine use, become clogged and essentially unusable, greatly impairing the user experience. While a variety of techniques of unclogging toilets exist, from mechanical methods like plungers or plumber's snakes to chemical techniques like enzyme treatments, all have notable downsides. Using a mechanical method, like the aforementioned plungers and plumber's snakes, to clear the drain requires a user to decontaminate their equipment once finished with the task, and often results in the user splashing unsanitary water or other material onto themselves or the bathroom floor while attempting to remove the clog. Alternate mechanical methods, like the use of a suction hose, can reduce the potential for mess but require more extensive cleaning.

Existing chemical methods of unclogging toilets are often problematic for a variety of other reasons. While a number of chemicals intended for the cleaning of drains, including toilets, are sold in stores, the vast majority of these chemicals are potentially hazardous and environmentally toxic and their use is discouraged. Other chemical techniques, like the use of bacterial enzymes, are regarded as more environmentally-friendly, but suffer from being extremely slow in removing clogs and limited in what kinds of clogs they can be used to remove.

Accordingly, there is a need to provide users with a means of unclogging toilets that functions rapidly, safely, and without potential for mess, and which does not pose a significant environmental hazard.

### SUMMARY

According to at least one exemplary embodiment, the invention provides a method for applying a specific chemical drain cleaner. A solid chemical compound formed with anhydrous sodium hydroxide, for example in a combination of flakes and beads, may be applied to the bowl of a stopped toilet in dry powder form to rapidly clear the stoppage without any other action on the part of the user.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows a process flow diagram describing the implementation of this process.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention,” “embodiments,” or “invention” do not require that all embodiments of the invention include the discussed feature, advantage or mode of operation.

In one exemplary embodiment, a chemical solution for clearing clogs may be described. The chemical solution may be used for clearing clogs of any variety, for example clogs in toilets, urinals, sinks, shower or bathtub drains, and the like. The chemical solution may be a dry solution and may include any of a variety elements. For example, the solution may be anhydrous sodium hydroxide. In some exemplary embodiments, the solution may be approximately 80% anhydrous sodium dioxide (NaOH), which may be formed as substantially flat flakes. In such examples, the anhydrous sodium hydroxide flakes may be formed of approximately 99.5% sodium hydroxide, approximately 0.1% chlorides (for example NaCl), and approximately 0.4% sodium carbonate (Na₂CO₃).

In a further exemplary embodiment, the anhydrous sodium hydroxide flakes may be mixed in a solution with anhydrous sodium dioxide beads, or caustic soda beads. The caustic soda beads may be similarly formed as the flakes, as described above. However, the beads may be formed as substantially bead-shaped or substantially pellet-shaped. These beads may be approximately 20% of the solution. The flakes and beads may be any size, for example about 0.75 mm in width or about 0.75 mm in diameter, respectively.

In still a further exemplary embodiment, the flakes and beads described herein may be mixed together to form a solution of anhydrous sodium dioxide. The solution of about 80% anhydrous sodium dioxide flakes with about 20% anhydrous sodium dioxide beads may form a desired solution whereby the flakes and beads intermingle in the mixture. Then, when the flakes and beads are poured onto an area where there is a clog, the flakes and beads may disperse on and around the clog to provide a desired reaction to remove the clog. For example, the flakes may be able to enter or access areas of the clog, or a drain, where the beads may not fit, and vice versa. Further, the shapes of the flakes and beads may be such that, as they react with the surrounding water, they are able to maneuver into more locations associated with a clog to better relieve or displace the clog.

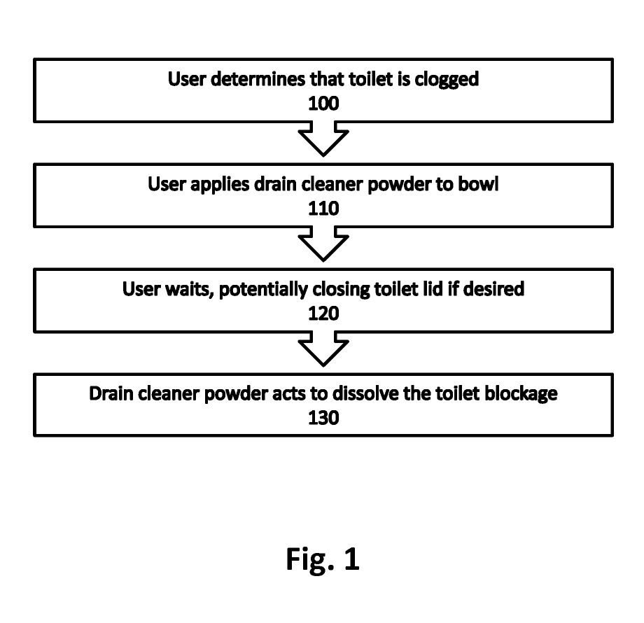

An exemplary process for the application of a solid chemical compound of about 80% anhydrous sodium hydroxide flakes and about 20% anhydrous sodium hydroxide beads may be shown in exemplary FIG. 1. In this exemplary method and process, a user may first identify that a drain, such as that of a toilet, is clogged or malfunctioning in 100. This may become known, for example, by attempting to flush a toilet and finding that it overflows, by observing debris left in the bottom of a toilet, by having another party indicate to them that a toilet is obstructed, or by some other manner of observation or otherwise acquiring this information.

The user, in 110, may then dispense a desired amount of the anhydrous sodium hydroxide solution of flakes and beads (henceforward identified by its primary, but non-limiting intended purpose, as drain cleaner) into an appropriate receptacle containing or filled with water, such as a toilet bowl or toilet tank. In one exemplary embodiment, dispensation of drain cleaner into a toilet bowl, toilet tank, or other receptacle may be accomplished by pouring in an appropriate amount of powdered drain cleaner from a bottle, wherein the bottle is marked with graduations, contains a pre-measured amount of powder approximately sufficient to dissolve a typical toilet blockage, or otherwise enables the user to add an appropriate amount of drain cleaner and not significantly more or less than is required to resolve the problem.

In a second exemplary embodiment, the user may pour in powder from a packet or capsule pre-filled with an appropriate amount of the drain cleaner. In a third exemplary embodiment, the user may add drain cleaner by placing or dropping in a dissolvable packet, capsule, pellet, bead, or nugget filled with and/or constituting drain cleaner. Dispensation of the drain cleaner may be done directly onto the blockage, from directly above the drain or blockage, from user height, or from any other position relative to the drain desired, and may or may not utilize the aid of protective equipment, including protective gloves. In another exemplary embodiment, drain cleaner may be dispensed from a bottle containing a pre-measured amount of powdered cleaner approximately sufficient to remove one toilet blockage, from approximately user height, and without requiring the user to wear any protective equipment. A user, in 120, may then wait for the drain cleaner to remove the clog. In some exemplary embodiments, the drain cleaner may activate upon contact with water and may clear a clog. The activation of the drain cleaner may include, for example, an exothermic reaction. The exothermic reaction of the anhydrous sodium dioxide with the water may then interact with the material causing the clog. The interaction of the anhydrous sodium dioxide with the materials causing the clog may dissolve, loosen, displace, wear away, or otherwise remove the clog. A user may then pour water, such as hot water of a temperature between about 60 degrees C. and 100 degrees C., into the toilet after approximately five minutes (which may vary depending on the size of the receptacle) to create a flush or flow of water through the drain.

As above, once the drain cleaner has been dispensed into a clogged drain, it, depending on the nature of the blockage, may take only a short time to dissolve or otherwise remove the clog. According to the exemplary embodiment wherein the method of applying drain cleaner is applied to a toilet, the user may optionally close the toilet lid to limit the release of odors from the clogged toilet during this time. According to the same exemplary embodiment, once the clog has been sufficiently dissolved or otherwise removed, the toilet may be flushed by the user to remove any remaining debris. In one example, the steps above may be repeated. Alternatively, the user may employ another manner to clear remaining parts of the blockage; for example, the user may employ a suction device to remove parts of the blockage that have not sufficiently dissolved and/or which are not intended to go down the drain.

Optionally, a final stage may be added wherein the sodium hydroxide solution created by the dispensation of drain cleaner into water may be neutralized or further diluted before disposal, in order to reduce the environmental impact of the solution or to avoid harm to any plumbing that might be sensitive to corrosion by sodium hydroxide solution. According to one embodiment, a neutralizing agent may be used, which may take the form of a strong or weak acid, for example an acetic or citric acid solution. According to a second embodiment, the sodium hydroxide solution may be diluted by the addition of an amount of water before disposal.

It may further be appreciated that the above process may be repeated any number of times in order to dissolve or otherwise remove clogging material from a drain.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A solution that removes clogs from pipes, comprising:
anhydrous sodium hydroxide, the anhydrous sodium hydroxide comprising substantially 80% anhydrous sodium hydroxide flakes and a remainder of anhydrous sodium hydroxide beads.

2. The solution of claim 1, wherein the anhydrous sodium hydroxide, when mixed with water, causes an exothermic reaction that removes clogs.

3. A method of removing clogs from drains, comprising:
mixing a solution of 80% anhydrous sodium hydroxide flakes with 20% anhydrous sodium hydroxide beads;
pouring the solution into a drain with a clog and water present;
having an exothermic reaction between the solution and the water; and
displacing the clog with the exothermic reaction.

4. The method of claim 3, further comprising:
pouring hot water into the drain after a predetermined period of time to flush the clog down the drain.
